(19) United States
(12) Patent Application Publication
(10) Pub. No.: US 2024/0017633 A1
(43) Pub. Date: Jan. 18, 2024

(54) CHARGING DEVICE AND METHOD FOR ELECTRICALLY CHARGING AN ELECTRIC VEHICLE

(71) Applicant: VOLTERIO GMBH, Graz (AT)

(72) Inventors: Christian FLECHL, Graz (AT); Robert MASCHER, Graz (AT)

(73) Assignee: VOLTERIO GMBH, Graz (AT)

(21) Appl. No.: 18/036,032

(22) PCT Filed: Nov. 10, 2021
(86) PCT No.: PCT/AT2021/060427

§ 371 Date: Jun. 21, 2023

(30) Foreign Application Priority Data
Nov. 10, 2020 (AT) A 50968/2020

(51) Int. Cl. B60L 53/35; B60L 53/16

(52) U.S. Cl. CPC B60L 53/35; B60L 53/16

(57) ABSTRACT

A charging device and method for electrically charging an electric vehicle includes a first coupling element connectable to a second coupling element arranged on the electric vehicle to produce an electrical connection. The the charging device includes a base, which can be at least partially sunk into the ground, and a movement apparatus, which connects the first coupling element to the base to be controllably moved relative to the base. The base includes a through-opening and a cover that closes the through-opening, so that, in a usage state, the first coupling element, with the cover open, is movable through the through-opening from a non-charging position sunk into the ground using the movement apparatus, to guide the first coupling element to the second coupling element to a charging position.

The invention relates to a charging device for electrically charging an electric vehicle, wherein the charging device comprises a first coupling element that can be connected to a second coupling element arranged on the electric vehicle in order to produce an electrical connection.

The invention furthermore relates to a method for electrically charging an electric vehicle, wherein, to electrically charge a storage battery of the electric vehicle, the electric vehicle is positioned at a charging device in order to connect a first coupling element of the charging device to a second coupling element arranged on the electric vehicle, in order to transfer electrical energy to the storage battery via the coupling elements.

Increasing requirements for a flexible and practicable electrical charging of electrical vehicles at charging devices or charging stations necessitate a high-density local availability of charging devices and a time-efficient electrical energy transfer between a charging station and a storage battery of the electric vehicle. To increase a local availability of charging devices, it is expedient to arrange charging devices at parking areas, in particular given a charging duration that often lasts for an extended time. To reduce a charging time, high electrical charging capacities are advantageous, which, however, often require cumbersome electrical charging cables, in particular charging cable lines and charging cable plugs with large cross sections, and can exhibit a not insignificant hazard potential due to high amounts of electrical power transferred. Known developments therefore aim at performing an electrical charging operation in an automated or automatic manner with the most reduced possible intervention by a user.

From the prior art, charging devices are known in which a coupling element of a charging device is connected in an automated manner to a corresponding coupling element of an electric vehicle in order to transfer electrical energy via the coupling elements. Charging devices have become known with multi-section robot arms that automatically perform the task of plugging the coupling element of the charging device into the coupling element of the electric vehicle when an electric vehicle is parked at the charging device for an electrical charging.

Electrical charging systems, in particular for garage applications, have also become known which are based on positioning a mobile charging robot, comprising a vertically extendable robot arm, on a parking surface of a parking area, and positioning an electric vehicle that is to be charged above the charging robot in order to then charge the electric vehicle from an underside by vertically extending the robot arm.

However, in solutions of this type, a complicated manner of functioning and pronounced susceptibility to soiling often emerge as problematic. This limits a use of automated charging devices, particularly when high-power charging is to be used, in practice usually in interior building applications.

This is addressed by the invention. The object of the invention is to specify a charging device of the type named at the outset which is embodied to be robust and have little susceptibility to soiling.

A further object is to specify a method for electrically charging of the type named at the outset with which the electrical charging can be performed robustly and with little susceptibility to soiling.

According to the invention, the object is attained by an apparatus of the type named at the outset if the charging device comprises a base, which can be at least partially, preferably essentially completely, sunk into the ground, and a movement apparatus, which connects the first coupling element to the base such that it can be controllably moved relative to the base, wherein the base comprises a through-opening and a cover, such as a lid for example, that closes the through-opening, so that, in a usage state, the first coupling element can, with the cover open, be moved through the through-opening from a non-charging position sunk into the ground using the movement apparatus, in order to guide the first coupling element to the second coupling element to assume a charging position or to charge.

The background of the invention is the idea of positioning a charging device or integrating a charging device into an environment such that the charging device constitutes a smallest possible limitation for a use of the environment and, at the same time, an electrical charging of an electric vehicle, which is performed using the charging device, takes place such that it is protected and preferably spaced apart from a user. A low interference with an environment by a charging device can be achieved if the charging device is arranged such that it is sunk into the ground or subsurface, for example the ground of a parking area. By providing that a charging of an electric vehicle occurs from below, or from the ground, preferably in that the electric vehicle is positioned above the charging device for the electrical charging, the charging device is shielded to a great extent against influences of weather, such as rain for example, by the electric vehicle during an electrical charging operation and, additionally, a spacing-apart from a user is created in a simple manner during charging. It is correspondingly advantageous if the base of the charging device is or can be arranged such that it is partially, preferably completely, sunk into the ground. Here, it is expedient if the base defines a holding region in which the first coupling element and in particular the movement apparatus are arranged in a non-charging position of the coupling element. As a result, these are particularly protected against external exposure, especially soiling. The base can, for example, be embodied with or as a hollow body, for example a hollow cylinder or tube. Because the charging device or the base comprises a through-opening and a cover that closes the through-opening, the possibility is easily created of guiding, with the through-opening open, the first coupling element, using the movement apparatus, through the through-opening to a second coupling element of an electric vehicle, which second coupling element is positioned above the charging device or through-opening, to assume the charging position of the first coupling element, in order to connect the coupling elements to one another for a transfer of electrical energy via said coupling elements, and, in a non-charging state, when the first coupling element is positioned in the non-charging position, to close the through-opening with the cover. In this manner, the first coupling element and in particular also the movement apparatus are particularly protected against soiling or exposure from the environment in the non-charging state. The cover is normally embodied as a lid or seal.

The cover, such as the lid, can be embodied with a heating device and/or can be connected to a heating device, so that the cover can be heated, particularly in the winter. As a result, a freezing of the cover can be avoided and the cover can be kept free of snow and ice.

The cover, such as the lid, can comprise a lock for a fully-open state. With this lock, the cover can be mechanically kept open. If a motor or drive is provided for opening the cover, a permanent energizing for keeping the cover open can be omitted. The lock can thereby be mechanically coupled with the movement apparatus, in particular such that the lock is activated or deactivated once a certain target position of the movement apparatus and/or of the first coupling element is reached.

The charging device is preferably embodied such that, in the usage state, in which the charging device is arranged in the ground or subsurface, the through-opening or the cover is, in the non-charging state, located essentially at the height of a ground level of the ground or subsurface, or is flush therewith. As a result, the charging device or the cover can be driven on by an electric vehicle and/or an electric vehicle can be parked over the charging device or cover. Often, it is sufficient if the cover, in a closed state, when it closes the through-opening, protrudes maximally 75 mm, in particular maximally 70 mm, preferably maximally 40 mm, in particular maximally 30 mm above the ground level or the ground surface of the ground. An electric vehicle can thus be positioned above the charging device, normally without there being a risk of an inadvertent contact or bottoming-out of an underbody of the electric vehicle with/on the cover. The aforementioned preferably also applies to an open state of the cover, when, in order to open the through-opening, the cover is moved away from the through-opening.

Usage state of the charging device typically denotes a state in which the base of the charging device is arranged such that it is at least partially, in particular completely, sunk into the ground or subsurface in order to electrically charge an electric vehicle from the ground or subsurface. This can be expediently implemented in that the first coupling element is guided through the through-opening in a pass-through direction from the non-charging position to a charging position using the movement apparatus. The pass-through direction is usually oriented in a direction orthogonal to an opening surface of the through-opening.

It is beneficial if the cover is embodied such that it can be driven on by an electric vehicle, for example an electric car or electric truck, or can bear the weight thereof. Expediently, the cover can be embodied to bear a weight of at least 1,000 kg, in particular 3,000 kg, preferably more than 10,000 kg. For this purpose, the cover can, for example, be formed with or from a metal alloy, in particular iron alloy, preferably steel alloy. For a movement of the cover to open or close the through-opening, a controllable cover drive is typically present.

It is advantageous if the first coupling element can be moved using the movement apparatus relative to the base along multiple, usually three, movement axes preferably aligned at a right angle to one another, in particular independently of one another, in order to assume the charging position. The first coupling element can thus be practicably guided to the second coupling element. For this purpose, the movement apparatus can comprise multiple, for example three, drives that are controllable independently from one another, wherein each drive controls a movement along one of the movement axes. It is beneficial if the movement apparatus comprises a parallel kinematic mechanism. The movement apparatus thereby typically forms a closed kinematic chain. As a result, a movement of the first coupling element can be carried out with high precision and little susceptibility to error using the movement apparatus. Specifically, it can be beneficial if the first coupling element can be moved using the movement apparatus relative to the base solely along one movement axis in order to assume the charging position. This enables a particularly simple and/or compact embodiment. This can be beneficial if a very precise parking of an electric vehicle is provided, for example as part of an autonomous control of the electric vehicle. In particular, the cover can then be embodied to be very small, for example with a diameter between 7 cm and 20 cm.

A high robustness can be achieved if the movement apparatus comprises multiple arms separately controllable from one another, which arms grip in an articulated manner the first coupling element at spaced-apart contact points of the first coupling element in order to move the first coupling element by displacing the contact points using the arms. The arms are thereby connected to or mounted on the base, often in an articulated manner, by their respective arm ends opposite from the contact points. A displacement of one of the contact points using the respective arm can occur, for example, in that the arm is moved as a whole and/or at least a partial segment of the arm is moved. For this purpose, the end of the arm opposite from the associated contact point can be displaceable in a guided manner relative to the base, for example using a guide component. The guide components are typically arranged on the base, or are embodied as parts of the base, such that they are spaced apart from one another at regular intervals. The guide components are normally embodied to displace arm ends of the arms, which arm ends are connected to said guide components, in a pass-through direction, in particular in a direction essentially orthogonal to an opening surface of the through-opening. Opening surface typically denotes the clear area or plane defined by a rim formed by the through-opening, through which area or plane the first coupling element can be guided to be passed through the through-opening. It has proven effective if at least three arms are present that are respectively connected to the base via a guide component such that they can be displaced relative to the base. Alternatively or cumulatively, a displacement of the contact points can occur in that the arm has a modifiable length, for example a length that is modifiable in a telescope-like manner. It is practicable if multiple or all arms are embodied in this manner. In a specific embodiment, the movement apparatus can be formed with a delta robot, for example. Alternatively, the movement apparatus can, for example, is embodied as a SCARA robot (“Selective Compliance Assembly Robot Arm”) or a gantry robot, in particular a three-dimensional gantry robot. The movement apparatus, or at least parts thereof, are thereby preferably embodied to not be self-locking. In a delta robot, this can be realized, for example, by an appropriate choice of the spindle pitch and of a motor transmission combination, so that the delta robot automatically lowers in the case of a power drip. An automatic lowering of the delta robot can be additionally supported by a spring force, in particular a vertically acting spring force, realized by an appropriate spring, and/or a weight of a cable and of the first coupling element. The cover only closes after a sufficient lowering of the delta robot, wherein this can occur without current if the cover is embodied with a lock that releases when the delta robot reaches a predetermined height.

For a simple movement sequence, it is advantageous if the movement apparatus comprises a lifting apparatus with which the first coupling element can be moved through the through-opening. This normally occurs in a pass-through direction, or in a direction essentially orthogonal to the opening surface of the through-opening. The lifting device can, for example, be embodied with a scissor lift mechanism and/or a telescope lift mechanism. It is beneficial if the movement apparatus comprises a lateral movement system with which the first coupling element can be moved in at least two dimensions or coordinates, preferably separately from one another, in a movement plane parallel to the opening surface of the through-opening. For this purpose, it has proven effective if the lateral movement system comprises a linear guide with which the first coupling element can be moved, normally in a straight line, preferably in the movement plane, wherein the linear guide can be rotated about a linear guide rotation axis oriented orthogonally to the movement plane. A movement of the first coupling element in the movement plane can thus be seen as corresponding to coordinates of a polar coordinate system. A mechanism for a movement of this type can be embodied to be very robust and to have few errors. It is expedient if the lifting apparatus can be moved using the lateral movement system or vice versa.

The drive of the movement apparatus can expediently be implemented hydraulically, pneumatically, and/or electromechanically.

It is advantageous if the movement apparatus is embodied to move the first coupling element laterally past a rim of the through-opening. This applies in particular in a state of the first coupling element where the coupling element has been guided through the through-opening in a pass-through direction to assume the charging position. As a result, an inaccurate positioning of the second coupling element outside of a projection of the rim of the through-opening can be compensated to a great extent.

It is beneficial if, in a movement plane parallel to the opening surface of the through-opening, the first coupling element has a traversable movement region using the movement apparatus with a diameter of at least 20 cm, in particular at least 30 cm, preferably at least 40 cm. This preferably applies in a state of the first coupling element where the coupling element has been guided through the through-opening in a pass-through direction. It is expedient if the first coupling element can be moved through the through-opening in a pass-through direction using the movement apparatus at least 20 cm, in particular at least 30 cm, preferably at least 40 cm, past a rim of the through-opening, or a ground level of the ground surface, or can assume a height of this type thereabove. In this manner, higher-clearance electric vehicles, for example electric trucks, can also be practicably electrically charged or contacted.

The first coupling element can be surrounded by a bellows. Aside from the first coupling element, the bellows can essentially completely cover the through-opening. An ingress of dirt, particles, snow, ice, or other solid materials is thus prevented.

It is advantageous if a motion accumulator coupled to the movement apparatus is present, with which motion accumulator movement energy of the movement apparatus can be intermediately stored and fed back to a drive of the movement apparatus with a time delay. In this manner, the drive of the movement apparatus can be designed to be weaker, since the drive can be assisted by the motion accumulator when under higher loads. For example, in the case of a vertical lowering movement of the movement apparatus or of the first coupling element, movement energy is stored in the motion accumulator and, during a lift movement of the movement apparatus or of the first coupling element, movement energy from the motion accumulator is transferred to the drive of the movement apparatus. Expediently, the motion accumulator can be implemented with one or more spring apparatuses, wherein the spring apparatuses can be deformed to store movement energy and can be relaxed to release movement energy. Alternatively, the motion accumulator can, for example, be embodied as a flywheel accumulator or electric accumulator, such as with one or more capacitors, for instance.

For a high robustness, it is advantageous if the base is formed with a hollow body in which, in the non-charging state, the first coupling element and preferably the movement apparatus are arranged. The hollow body can, for example, be embodied to be tubular or cup-shaped. It shall be understood that the hollow body normally comprises openings, for example the through-opening and/or one or more line feed openings for the feed-through of electrical lines, and/or water outlet openings for rainwater runoff. Typically, the hollow body has a polygonal, in particular rectangular or square, or round cross section.

It is practicable if the cover can be moved essentially parallel to an opening surface of the through-opening to open the through-opening. Thus, opening and closing can be carried out with little need for space. For a simple construction, it is beneficial if the cover can be opened using a rotation motion, typically about a rotation axis parallel to a line perpendicular to the opening surface of the through-opening, or a using a linear motion, typically essentially parallel to the opening surface of the through-opening. To open the cover by means of rotation motion, it is expedient if the cover can be rotated about a rotation axis that is arranged eccentrically from the through-opening. The rotation axis is thereby normally oriented parallel to a line perpendicular to the opening surface of the through-opening. It is beneficial if the rotation axis is, in relation to an envisaged longitudinal direction of the electric vehicle, obliquely arranged in front of a center point or area centroid of the through-opening in the charging state of the electric vehicle. As a result, a space requirement or a deflection of the cover when the cover is opened can be kept small. A risk of a collision of the cover with an electric vehicle that is to be charged, in particular with the tires thereof, when the cover is opened can thus be reduced. Normally, the rotation axis is thereby positioned essentially at a right angle to the longitudinal direction of the electric vehicle. The rotation axis is preferably arranged such that, in a cross section through the rotation axis, a first reference line intersecting the rotation axis and leading through the center point or area centroid forms with a second reference line oriented in the longitudinal direction of the vehicle and leading through the center point or area centroid an angle between 10° and 80°, in particular between 15° and 60°, preferably between 20° and 45°. It is practicable if the rotation axis is formed with a cover rod connected to the cover, which cover rod is connected to a cover rod guide such that it can be rotated relative to said cover rod guide, wherein the cover can be set in rotational motion by a rotation of the cover rod. The cover rod is thereby usually rotatably mounted in the cover rod guide. It is particularly beneficial if the cover rod can be placed in rotational motion by a rotation of the cover rod guide, wherein the cover rod and the cover rod guide are connected by means of a static friction connection. In this manner, the cover rod and the cover rod guide can be mechanically decoupled, so that the static friction connection can be released if there is a blockage of the cover. Expediently, a coefficient of static friction for the static friction connection is chosen such that the static friction connection is released or overcome when loaded with a predefined force opposing the rotation motion. For this purpose, a static friction body arranged on the cover rod or cover rod guide is typically provided, the surface of which is pressed against a surface of the cover rod guide or cover rod, respectively, for a rotation of the cover while creating a static friction. It is beneficial if the static friction connection is embodied such that the static friction coefficient increases as the opening of the cover progresses. A static friction connection of this type can, for example, be implemented in that the static friction body has a sloped surface with which the static friction is produced, for example in that the static friction body is embodied as a wedge element. The cover rod guide can, for example, be embodied as a guide tube or hollow cylinder that is connected in a form fit to the rotation rod, or in which the rotation rod is inserted in a form fit. Alternatively or cumulatively, a linear motion of the cover can be implemented in that the cover is arranged such that it can be displaced in a guided manner in one or more guide mounts, typically in a plane parallel to the through-opening surface. The cover can thus be easily opened and closed by a displacement of the cover in a linear or straight-line direction. This is beneficial for a high stability, in particular with a very large and heavy cover.

A particularly soiling-resistant cover movement can be implemented if, to open the through-opening, the cover can be raised in a pass-through direction of the through-opening and can subsequently be moved essentially parallel to the opening surface of the through-opening. Thus, during a movement of the cover, it can be avoided that potential soiling is shifted by the cover movement or reaches the through-opening or base. A raising of the cover normally takes place in a direction essentially orthogonal to the opening surface of the through-opening. The displacement parallel to the opening surface can, for example, take place in accordance with an, in particular aforementioned, rotation motion and/or linear motion. Typically, the cover is raised such that at least one gap forms with a thickness of multiple millimeters, in particular at least 3 mm, often at least 5 mm, preferably with a thickness between 3 mm and 5 mm, between the cover and a resting surface against which the cover bears when closing the through-opening. The resting surface can, for example, be formed by the rim of the through-opening or a rim strip explained below. In this manner, a low-friction movement of the cover, in particular parallel to the through-opening, can then occur, wherein an ingress of soiling into the through-opening can be avoided. The cover movement can, for example, be implemented in that the aforementioned cover rod and cover rod guide are connected to a guide rail inserted in a form fit in a guide groove, in order to control a relative movement between the cover rod and cover rod guide using a shape of the guide groove. The cover rod guide can thereby comprise the guide groove and the cover rod the guide rail or vice versa. Expediently, the guide groove can comprise a first guide groove section, which effects the raising of the cover, and a second guide groove section, which effects a rotation of the cover.

A mechanism for the cover, in particular for a lid as a cover, can be embodied with a sliding block guide so that the cover runs completely, or at least essentially, vertically upwards at the start of an opening operation and then turns out to the side. A smooth opening movement and, during closing, closing movement thus result. For this purpose, a corresponding sliding block guide can be provided, for example with a threaded nut and a spindle that is driven directly via a motor or indirectly via a transmission means such as a belt.

If a threaded nut is provided for a sliding block guide, said nut can externally comprise two opposing bearings attached at an offset height. Each of these two bearings then has its own path; if both bearings were at the same height, the paths for guiding would intersect. The threaded nut is connected to the lid in a fixed manner via a shaft. In a rotation motion during the rotating-open of the lid or the cover in general, the lid or the cover can still gain some height, or can only twist horizontally without any height gain (depending on the slide path). It is advantageous if there is a corresponding opposing force (with a coil spring, for example), so that, when the motor with a spindle that is not self-locking is currentless, the cover automatically slowly rotates shut and then lowers again (provided that the movement apparatus has already fully retracted beforehand).

A high soiling resistance can be achieved if the base comprises a rim strip that can be extended relative to a foundation of the base, so that, in the extended state, the rim strip at least partially, preferably essentially completely, runs around the through-opening in order to form a barrier against dirt that ingresses into the through-opening when the cover is open. Typically, the rim strip can be extended in a pass-through direction of the through-opening, in particular in a direction orthogonal to the opening surface of the through-opening. Normally, in the usage state of the charging device, the rim strip can be extended from a low position, in relation to the ground level, into a high position in which the rim strip typically protrudes past an environment surface or ground surface adjacent to the rim strip. It is expedient if the rim strip is embodied such that, in the extended sate, it protrudes past the rim of the through-opening and runs around said rim at least partially, preferably essentially completely, in order to form a barrier against dirt that ingresses into the through-opening when the cover is open. It is usually provided that the rim strip does not protrude past the through-opening or the rim thereof in a non-extended state of the rim strip.

A high application practicability can be achieved if the rim strip is embodied such that it can be extended in a pass-through direction of the through-opening during an opening movement of the cover, in order to form a barrier against an ingress of soiling. It is expedient if the rim strip is mounted in a spring-loaded manner so that the rim strip is extended by means of spring force when the cover is opened. Accordingly, the rim strip can be retracted against the spring force during a closing of the cover, in particular as a result a force applied to the rim strip by the cover. In a state of the through-opening that is closed by the cover, the rim strip typically bears against the cover, normally against a side of the cover facing the through-opening. If the cover is raised for opening the through-opening, an opening gap forming between the rim of the through-opening and the cover can thus be compensated with the rim strip up to a certain opening gap height of the opening gap. Alternatively or cumulatively, it can be beneficial if the rim strip can be controllably extended and retracted by means of an, in particular electric, hydraulic, or pneumatic, drive.

Depending on the specific embodiment, one or more rim strips of this type can be expedient. In particular, it can be beneficial if multiple rim strips are arranged such that they are parallel, at least in sections, and/or such that they enclose one another and/or are concentric with one another, at least in sections, in order to form a manifold barrier against soiling. It has proven effective if, in an extended state, the rim strip protrudes past the rim of the through opening, or an environment level or ground level adjacent thereto, by at least 2 cm, in particular 3 cm, preferably 4 cm, particularly preferably 5 cm, normally between 2 cm and 10 cm. An efficient barrier against soiling is thus created. This is of particular importance in so far as soiling can impede or prevent an envisaged closing of the cover, and can thus impair a proper functioning of the charging device. In a particularly robust embodiment, the rim strip can be formed with an extendable cylinder envelope. This is preferably embodied such that, in the extended state, it protrudes past the ground level, in particular in the aforementioned manner, and in particular encloses the through-opening or the rim thereof.

It is beneficial if at least one sensor element is present for measuring an impediment to an opening movement or closing movement of the cover. An impediment of this type can, for example, be present due to soiling, such as small stones or small branches. A jamming of impediments of this type can thus be prevented. The sensor element can, for example, be embodied as a pressure strip that detects a compressive force acting on the pressure strip when an impediment presses against the pressure strip, for example. It is expedient if the pressure strip is arranged laterally on the cover and/or on a side of the cover facing the through-opening. The pressure strip can be arranged at least partially, in particular completely, circumferentially around an area centroid of the cover, or can be arranged such that it at least partially, in particular completely, runs around the through-opening. The pressure strip can, for example, be embodied to be compressible, wherein a compression of the pressure strip is detected. This can be implemented with little error, with a detection or measurement of a capacitive change in spacing between to detection surfaces of the pressure strip spaced apart from one another. Multiple sensor elements of this type are preferably provided. Alternatively or cumulatively, the sensor element can be implemented as a proximity sensor, for example based on electromagnetic or acoustic reflection.

For a high insensitivity to soiling, it is advantageous if the cover comprises on the underside thereof one or more runoff guides, in order to conduct away via the runoff guides water collecting on the underside of the cover. It is expedient if the runoff guides are embodied to channel off water from a center region of the underside of the cover in the direction of a rim region of the cover. It can thus be prevented that water drips onto the first coupling element located thereunder or onto the movement apparatus. It is practicable if the runoff guide is formed with one or more protrusions, in particular edges, of a base surface of the cover, in order to channel off water along the protrusions.

It is advantageous if the first coupling element and/or the movement apparatus are mounted on the base with a spring mechanism, in order to compensate a change in spacing between the second coupling element and the base in a state of electrical charging. Thus, during a charging operation, when the first coupling element is connected to the second coupling element, a movement of the second coupling element or electric vehicle in the direction of the base can be compensated. The spring mechanism can be formed with one or more spring elements. Expediently, a damping can be present which damps a mechanical oscillation of the spring mechanism. The spring mechanism can, for example, be arranged between the coupling element and the movement apparatus and/or between the movement apparatus and the base, for example on the aforementioned arms and/or guide components of the movement apparatus. It is beneficial if the spring mechanism is embodied such that the first coupling element exhibits a deflection between 30% and 70%, in particular approximately 50% of the total spring range. This preferably applies in the state of electrical charging, when the first coupling element is connected to the second coupling element.

It is beneficial if the movement apparatus is embodied such that, in the case of a loss of the operating current or energy supply thereto, it the first coupling element is automatically moved back into the non-charging position. This can be implemented in that the movement apparatus is embodied to not be self-locking, so that a return movement of the first coupling element is effected by an acting gravitational force. Alternatively or cumulatively, an emergency energy store, such as storage battery, can be provided in order to make available an energy necessary for a return movement of the first coupling element into the non-charging position. It is practicable if the cover is embodied such that, in the case of a loss of the operating current or energy supply thereto, it is automatically moved back into a closed position in which the cover closes the through-opening. For this purpose, a return spring can be present, for example, which is elastically deformed against a spring force of the return spring during an opening of the cover, so that the cover can be transferred into the closed position by means of a relaxing of the return spring. It is expedient if, alternatively or cumulatively, the emergency energy store is embodied to power a closing of the through-opening with the cover.

It is advantageous if a heating device is present in order to heat the cover, a rim region of the through-opening, and/or the movement apparatus for a deicing. The heating device can practicably be formed with one or more filaments. To supply energy to the heating device, a heating device storage battery and/or heating device capacitor, preferably in the form of a supercapacitor (“supercap”) or ultracapacitor, can be provided.

For a soiling protection of the first coupling element, it is beneficial if the first coupling element comprises an, in particular controllably, openable protective covering which covers the first coupling element at least in sections, preferably completely. The protective covering is usually connected to the first coupling element in a fixed manner. Preferably, the protective covering is opened when a predefined height is reached in a pass-through direction, for example by moving the protective covering, or a part thereof, away. Accordingly, it is beneficial if the second coupling element comprises an, in particular controllably, openable protective covering which covers the second coupling element at least in sections, preferably completely. This can be embodied analogously to the aforementioned protective covering of the first coupling element. It shall be understood that the protective covering of the second coupling element, or the embodiment thereof, is typically independent of whether the first coupling element comprises a protective covering or is embodied like said protective covering.

To reduce soiling, it is expedient if a protective sheathing is present which is embodied such that it extends from the first coupling element to at least the through-opening in the charging state. In this manner, the first coupling element and the part of the movement apparatus which is guided through the through-opening in the charging state are protected against soiling. The protective sheathing can preferably be embodied to be reversibly extendable. Expediently, a section of the protective sheathing can be connected to the first coupling element and can be moved along therewith. The protective sheathings can be formed with a bellows, for example.

It has proven effective if, for positioning an electric vehicle at the charging device, a relative position between the charging device and the electric vehicle, in particular the second coupling element thereof, can be determined by means of ultrasonic detection. For this purpose, the charging device can comprise one or more ultrasonic determination elements in the form of ultrasonic receivers and/or ultrasonic transmitters. It has proven effective if the charging device comprises one or more ultrasonic receivers in order to identify an ultrasonic signal emitted by an ultrasonic transmitter arranged on the electric vehicle or on the second coupling element, in order to determine the relative position. The determination of the relative position normally occurs based on a travel-time measurement of the ultrasonic signal between the ultrasonic transmitter and ultrasonic receiver. It is advantageous if one or more ultrasonic determination elements, normally ultrasonic receivers, are connected to the first coupling element in a fixed manner. Correspondingly, one or more ultrasonic determination elements, in particular ultrasonic transmitters, are usually connected to the second coupling element in a fixed manner. Thus, a relative position between the coupling elements can be determined for assuming the charging position of the first coupling element or during a movement of the first coupling element to the second coupling element using the movement apparatus. It is expedient if multiple ultrasonic determination elements are arranged such that they are spaced apart from one another, normally fixed relative to one another, in order to determine the relative position by means of triangulation. For this purpose, the ultrasonic determination elements can practicably be arranged about the cover, in particular at regular intervals from one another.

For a precise detection, ultrasonic receivers can be embodied as MEMS components (Micro Electro-Mechanical Systems components). It has then proven effective if the ultrasonic receivers are implemented as microphones, in particular MEMS microphones. MEMS microphones are often load-sensitive, for which reason it is beneficial if they are protected with an additional cover component in a non-operational state. Alternatively or cumulatively, it can be beneficial to use one or more ultrasonic determination elements that are not embodied as MEMS components. Ultrasonic determination elements of this type are particularly robust and can in particular be installed without an additional cover component. The ultrasonic determination element is then usually formed with a piezo element arranged in a metal housing. Normally, the ultrasonic determination element is implemented with a metal cylinder that is encapsulated to be watertight.

To avoid soiling, it is beneficial if the at least one ultrasonic determination element can be covered with an openable cover component. The cover component can be openable with a rotating and/or displacing of the same, or of a part thereof. This applies in particular in the case of MEMS microphones, since these are often load-sensitive. It is practicable if the cover component is formed with multiple cover component segments that can be displaced relative to one another, wherein a covering of the ultrasonic determination element can be produced or reversed through a relative displacement of the cover component segments. A high robustness can be achieved if the cover component forms a dome surrounding the ultrasonic determination element, wherein the dome is formed with multiple dome segments that can be displaced relative to one another.

It has proven effective if one or more of the ultrasonic determination elements are arranged on an extension element that can be extended out of an extension base, so that an operation of the ultrasonic determination element is enabled in an extended state of the extension element and the ultrasonic determination element is covered by the extension base in a retracted state of the extension element. In this manner, transmitters or sensors can be extended as needed and are protected against soiling in a retracted state. For this purpose, one or more ultrasonic determination elements can be arranged on an envelope surface of the cylinder or integrated therein. Expediently, one or more extension elements can be present, in particular arranged on the base and/or on the first coupling element and/or on the cover. The extension base can be formed by a section of the base, of the second coupling element, or of the cover, or can be integrated into such a section. It is practicable if the extension element can be vertically extended out of the extension base. It is beneficial if the extension element is mounted in a spring-loaded manner on the extension base, so that the extension element, when there is a force load thereon, for example when it is rolled over by an electric vehicle, can be pressed at least partially or completely into the extension base.

Alternatively or cumulatively to the relative position determination by means of ultrasonic transmission, it is expedient if a relative position between the charging device and the electric vehicle, or between the coupling elements, occurs by means of UWB radio signal transmission (ultra-wideband radio signal transmission). A frequency range with a bandwidth of more than 500 MHz is normally used thereby. For this purpose, the charging device can comprise one or more UWB determination elements in the form of UWB receivers and/or UWB transmitters. The UWB determination elements, in particular UWB receivers and UWB transmitters, can, analogously to the aforementioned ultrasonic determination elements, in particular ultrasonic transmitters and ultrasonic receivers, be arranged on the charging device and the electric vehicle, or the first coupling element and the second coupling element. A relative position determination thereby normally occurs based on a travel-time measurement of a UWB radio signal transmitted between a UWB transmitter and UWB receiver. In particular, a UWB transmitter can be arranged on the first coupling element and a UWB receiver on the second coupling element, for example; reverse configurations are also possible. It is also possible that UWB elements, that is, UWB transmitters or UWB receivers, are arranged on the cover, such as a lid. For example, multiple dual antennas can be arranged on the cover, such as a lid, in particular in a square. The antennas can be encapsulated to be watertight, for example by a jacket having a plastic such as a resin or a silicone. A marked precision can thereby be achieved if the UWB transmitter or UWB receiver is located in a center region of the respective coupling element in a cross section through the respective coupling element.

It is beneficial if one of the coupling elements, for example the first coupling element, comprises a magnetic sensor, in particular a Hall sensor, and the other coupling element, for example the second coupling element, comprises a magnet, for example a permanent magnet or a coil generating a magnetic field, wherein the magnetic sensor is embodied to detect a presence and/or a spacing from and/or an orientation to the magnet in a relative approach of the coupling elements. As a result, an accuracy of a relative position determination of the coupling elements can be increased. The Hall sensor is preferably embodied as a 3D Hall sensor, so that in particular a three-dimensional vector of a magnetic flux density can be measured. It shall be understood that the magnetic sensor can also be arranged in the second coupling element and the magnet in the first coupling element, even though an arrangement of the magnetic sensor in the first coupling element has proven to be more practicable. Alternatively, it is possible that the magnetic sensor is arranged on the movement apparatus. For a high precision, it is beneficial if multiple magnetic sensors of this type, in particular multiple Hall sensors, are provided. Expediently, these can be differentially evaluated for the relative position determination. As a result, influences of magnetic interference fields can be minimized. For example, two or more Hall sensors can be arranged on, or installed in, the first or second coupling element, and signals from the Hall sensors can be differentially evaluated for the relative position determination between the coupling elements.

In particular, it has proven effective if an aforementioned relative position determination is implemented by means of ultrasonic transmission or an aforementioned relative position determination is implemented by means of UWB radio signal transmission combined with an aforementioned magnetic detection by means of magnetic sensors. A high precision can thus be achieved, in particular if a 3D Hall sensor is used as a magnetic sensor. For a very high accuracy, however, all three variants can also be combined.

Alternatively or cumulatively to the aforementioned relative position determination by means of magnetic sensor, a relative position determination can be carried out by means of a camera, in order to determine a relative position between the coupling elements using camera recordings. A high accuracy can be achieved, as stated above, using a combination with ultrasonic transmission or UWB radio signal transmission. Alternatively or cumulatively, an infrared unit, comprising one or more infrared proximity sensors, can also be provided in order to determine a relative position between the coupling elements.

It is advantageous if a charging system for electrically charging an electric vehicle is present, comprising an, in particular aforementioned, charging device and a second coupling element that can be arranged on an electric vehicle, wherein the first coupling element and the second coupling element can be connected to one another in a form fit to produce an electrical connection. According to the aforementioned features and effects of the charging device, a charging of an electric vehicle can thus be performed in a robust manner and with little susceptibility to soiling.

For a high robustness, it is advantageous if, to produce an electrical connection between the first coupling element and second coupling element, at least one first contact element of the first coupling element can be electrically contacted with at least one second contact element, corresponding to said first contact element, of the second coupling element while producing a compression connection, wherein the compression connection occurs with a deformation of a helical spring. Compression connection thereby denotes a reversible force-fit connection or friction-fit connection. It is beneficial if the helical spring is obliquely wound in relation to a center line through the coils thereof. A robust, impact-resistant connection between the contact elements can thus be produced. Because the coils of the spring are obliquely wound in relation to the center line through the coils of the spring, a consistent deformation behavior of the spring can be ensured even in the case of successive multiple deformations, and a high soiling resistance can be ensured. In a non-tensioned state of the spring, the coils are thereby typically obliquely oriented in relation to the center line through the coils at an angle between 20° and 70°, often between 30° and 60°, in particular between 40° and 50°. The helical spring can thereby be arranged on the first and/or second coupling element.

The helical spring is typically embodied such that the center line is formed in the shape of a circle segment or circle. Preferably, the center line is embodied to be closed or circular, that is, the helical spring then forms a circular spring. A high durability can be achieved if the deformation of the helical spring takes place at an angle, in particular orthogonally, to the center line. The electrical connection can be practicably implemented respectively between multiple first contact elements and second contact elements each corresponding to one another.

Accordingly, it is advantageous if, to produce an electrical connection between a first coupling element and second coupling element, the first coupling element comprises at least one first contact element and a helical spring, preferably wound obliquely in relation to a center line through the coils thereof, in order to electrically contact the first contact element with a second contact element, corresponding to said first contact element, of the second coupling element while producing a compression connection formed with a deformation of the helical spring. It shall be understood that the first and/or second coupling element can be embodied in such a manner.

It is expedient if the helical spring is arranged such that, in a connected state of the coupling elements, it is arranged between the respective first contact element and the second contact element corresponding to said first contact element, so that, in a transfer of electrical energy between the contact elements, energy is transferred via the helical spring. Multiple contact points both between the spring and the first contact element and between the spring and the second contact element can thus be produced with the spring, whereby a very uniform current distribution, in particular even with a high degree of soiling, can be achieved through a precisely defined number of contact points. This applies in particular if the helical spring is obliquely wound.

For a high robustness, it is advantageous if the at least one first contact element and/or the at least one second contact element is essentially circular, preferably annular, in a cross section through the contact element, and the helical spring, or the center line thereof, runs around said contact element(s). The helical spring can thereby be connected to the first contact element or second contact element in a form-fitting, force-fitting, and/or materially bonded manner. It is particularly beneficial if the helical spring is arranged in a form fit on one of the contact elements, for example in a recess of the first or second contact element. It is thereby typically provided that the helical spring projects out of the recess in order to create a compression connection with the respective other contact element. Multiple helical springs of this type can also be provided, which springs are arranged on the first contact element and/or second contact element.

It has proven effective if the respective coupling element comprises in a cross section through said coupling element multiple circular, preferable annular, first or second contact elements, wherein the contact elements are arranged in an offset manner, in particular concentrically with one another, wherein for respectively corresponding contact elements of the two coupling elements, one, in particular aforementioned, helical spring is present, the center line of which runs around at least one of the contact elements corresponding to one another, in order to create an electrical contact between the corresponding contact elements while producing a compression connection with the respective helical spring. This enables a reliable and robust contact between the contact elements, in particular in the case of successive multiple deformations. Expediently, this can be implemented for producing a multi-phase electrical connection, in that, for each phase, a first or second contact element of this type is present on the first coupling element and/or second coupling element, wherein for respectively in-phase contact elements a helical spring of this type is present and runs around said contact elements in the aforementioned manner. The aforementioned applies analogously for a ground conductor (PE conductor) or a neutral conductor (N conductor), for which at least one contact element each can likewise be present. Normally, first contact elements and second contact elements are respectively present for multiple phases, in particular for one phase, two phases, or three phases, and for a neutral conductor and, if necessary, a PE conductor. Alternatively, for a direct-current charging, first contact elements and second contact elements corresponding to one another, in particular embodied as aforementioned, can, in an analogous manner, respectively be present for a positive line pole (DC+) and a negative line pole (DC−) and, if necessary, for a ground conductor (PE conductor). Normally, the helical springs are arranged either on the first coupling element or on the second coupling element, or on the first contact elements or the second contact elements.

A simple and robust construction can be achieved if, in a state of contact between the first contact elements and second contact elements, multiple helical springs are arranged concentrically with one another in a cross section through the coupling elements. Normally, the helical springs are thereby embodied with different diameters and circumferences, and are arranged such that they are spaced apart from one another about a common center point.

For a low-error connection, it is beneficial if multiple helical springs, or the center lines thereof, are essentially arranged in a plane, especially if they are assigned to different phases or poles. It is beneficial for high degree of safety if the helical spring that is assigned to a contact element of a protective conductor is arranged to be offset from other helical springs such that, when the coupling elements are being connected, a compression connection with the helical spring assigned to the protective conductor is implemented first and then a compression connection with the other helical springs. For this purpose, the helical spring of the protective conductor can be arranged such that it is positioned in front of other helical springs of the same coupling element against a connection direction of the coupling elements. Accordingly, the first coupling element and/or second coupling element can be embodied, in a cross section through said coupling element, with such an arrangement of helical springs arranged concentrically with one another, which helical springs are in particular arranged in a plane in the aforementioned manner. However, the respective helical springs can also be distributed on the two coupling elements.

Depending on the electrical power to be transferred, the first contact elements and/or second contact elements can be embodied with different thicknesses or cross section areas. To transfer high amounts of power, it can be beneficial if one or more cooling apparatuses, for example cooling channels through which a coolant can flow, are present in order to cool the contact elements.

It is expedient if one of the coupling elements comprises a coupling plug and the other coupling element comprises at least one coupling receptacle corresponding in shape to the coupling plug, in order to connect or contact the coupling elements with one another in a form fit and/or force fit by an at least partial, preferably complete, insertion of the coupling plug into the coupling receptacle. For a practicable connection, it is beneficial if the coupling elements are embodied to be self-centering with one another. It is thereby typically provided that at least one outer surface of the coupling plug, which outer surface enters into connection with the coupling receptacle, is embodied to correspond in shape to a guide surface of the coupling receptacle such that, in the case of a not entirely flush alignment of the coupling plug with the coupling receptacle during the connection thereof, the coupling plug is guided into the designated contact position by the guide surface of the coupling receptacle. It is expedient if the outer surface and the guide surface are embodied, at least in sections, as a rotation surface having a rotation axis in the direction of an insertion direction of the coupling plug, preferably essentially conically, at least in sections, in particular as an envelope surface of a cone or of a truncated cone. It is typically provided that the outer surface is embodied such that it axially tapers in the insertion direction. The coupling receptacle normally comprises a shape corresponding thereto, in order to insert the coupling plug at least partially into the coupling receptacle. It is preferred if the coupling plug can be inserted into the coupling receptacle independently of skewing in relation to an axis of insertion into said coupling receptacle.

It is expedient if the first and/or second coupling element comprises electrical signal contacts for transmitting control signals between the coupling elements in the contacted state of the coupling elements. As is customary in the art, a CP contact (control pilot contact) and/or a PP contact (proximity pilot contact) are normally present. The signal contacts can be embodied as part of a CAN bus system and/or LIN bus system. The electrical signal contacts can, for example, be formed such that they are spring-mounted, in particular with spring pins.

It is beneficial if the first coupling element is mounted in a direction orthogonal to a contact direction in which the first coupling element can be contacted with the second coupling element, against a spring force applied by one or more centering springs. Thus, in the case of a lateral force load on the first coupling element, a deflection ability of the first coupling element, or an automatic centering, is ensured. The centering spring can, for example, be implemented with a spring plate element, in particular a spring plate tab. Expediently, the centering spring is arranged circumferentially about the first coupling element, or multiple centering springs are arranged along a circumference of the first coupling element. The second coupling element can be mounted analogously with one or more centering springs.

Advantageously, a plug connection for connecting electrical lines, in particular for charging an electric vehicle, is proposed, comprising a first coupling element and a second coupling element, which can be connected to one another in a form fit to produce an electrical connection, wherein the first coupling element comprises at least one first contact element and the second coupling element comprises at least one second contact element, which contact elements can be electrically contacted with one another when the coupling elements are connected while producing a compression connection, wherein the compression connection is created with a deformation of at least one helical spring wound obliquely in relation to a center line through the coils thereof. It shall be understood that the first coupling element and the second coupling element can thereby be embodied, according to the aforementioned form, as part of a charging device or charging system, in particular to achieve analogous effects. A plug connection of this type can—independently of a use in a charging device for electric vehicles—be expedient for connecting electrical lines. With corresponding advantageousness, a first coupling element and second coupling element of this type are proposed for producing a plug connection for the connection of electrical lines.

For a high soiling resistance, it is beneficial if an aforementioned protective covering covers one or more, preferably all, of the first contact elements of the first coupling element. It is practicable if the protective covering is embodied such that it is loaded with a spring force, so that the protective covering can be opened by an application of a force load against the spring force. The spring force can be effected using one or more spring components connected to the protective covering. An automatic covering or closing by the protective covering can thus be practicably implemented when there is no force load. Expediently, the force load for opening the protective covering can be applied using a section of the first coupling element or second coupling element, for example during an approach or contacting of the first coupling element to or with the second coupling element, in particular during an approach of the first contact element to the second contact element. The section can, for example, be formed with the first or second contact elements. It is advantageous if the protective covering is mounted such that it can move relative to the first contact elements, so that the force load is effected by displacing the protective covering relative to the first contact elements, for example in that the first contact elements or second contact elements apply a pressure force to the cover. Multiple protective coverings can also be provided which cover different first contact elements, in particular in the aforementioned manner. Accordingly, it is beneficial if the second coupling element comprises a protective covering of this type. This can be embodied analogously to the aforementioned protective covering of the first coupling element, wherein the protective covering covers one or more, preferably all, of the second contact elements of the second coupling element.

The charging device or the charging system or the plug connection can practicably be used for a passenger transport system and/or cargo transport system, for example in a logistics distribution center such as a logistics hub, or a taxi stand.

The first coupling element is normally connected to one or more electrical lines in order to exchange electrical energy transported via the electrical lines between the first coupling element and second coupling element using the first coupling element in the charging state. To carry out an efficient energy transfer, it is beneficial if a cooling device is present in order to cool the electrical lines. The cooling device can, for example, be formed with an, in particular liquid or gaseous, coolant which surrounds the electrical lines. For example, the cooling device can comprise a coolant circuit in order to cool the electrical lines using coolant of the coolant circuit.

It is practicable if a strain release is present for the electrical lines, in order to reduce the load on a terminal connection of the electrical lines to the first coupling element with regard to pulling forces acting on the electrical lines. The electrical lines are preferably connected to the first coupling element by means of ultrasonic welding or laser welding. This enables a robust and space-saving connection.

It has proven effective if the movement apparatus is embodied in the aforementioned manner with multiple arms, in particular as a delta robot. Practicably large bending radii of the electrical lines can thus be implemented so that a strain on the electric lines is reduced.

Advantageously, a method for electrically charging an electric vehicle of the type named at the outset is implemented, wherein a charging device, in particular according to the invention, is present, wherein the base is at least partially, preferably essentially completely, sunk into the ground and the electric vehicle is positioned above the charging device, whereupon, with the cover open, the first coupling element is moved through the through-opening from a non-charging position sunk into the ground using the movement apparatus, in order to guide the first coupling element to the second coupling element to assume a charging position or to charge. According to the aforementioned advantages of a charging device for electrically charging an electric vehicle, or of a charging system, which advantages enable an electrical charging that is robust and has little susceptibility to soiling, a charging that is robust and has little susceptibility to soiling can also be implemented with a method for electrically charging an electric vehicle using a charging device of this type. It shall be understood that the method according to the invention can be embodied according to or analogously to the features, advantages, and effects which have been described, in particular as above, within the scope of a charging device according to the invention, or of a charging system with a charging device of this type, or analogously also vice versa.

It is advantageous if, after a positioning of the electric vehicle above the charging device, the first coupling element is moved into a pre-position for rough alignment depending on the positioning of the electric vehicle prior to an opening of the cover. In the pre-position, the first coupling element is preferably located essentially vertically below the second coupling element, so that the first coupling element can be guided to the second coupling element by a vertical movement. An assumption of the charging position can thus be completed in a time-efficient manner.

Some exposed motors, or preferably all envisaged motors, should be encapsulated to be watertight. For this purpose, a jacket having a plastic can respectively be provided. The plastic can be attached or applied by extrusion coating. The plastic(s) is/are typically resins or silicones. For electronic components, the same thing applies analogously.

The charging device can, as such, be arranged in the earth or in the ground in general. It possible and preferred, however, if the charging device is hung in a freely suspended, possibly also spring-mounted, manner in a load handling means such as concrete rings or the like. As a result, a loading is minimized when driven on, in particular if the cover is mounted in a springing manner.

Additional features, advantages, and effects follow from the exemplary embodiments described below. In the drawings which are thereby referenced:

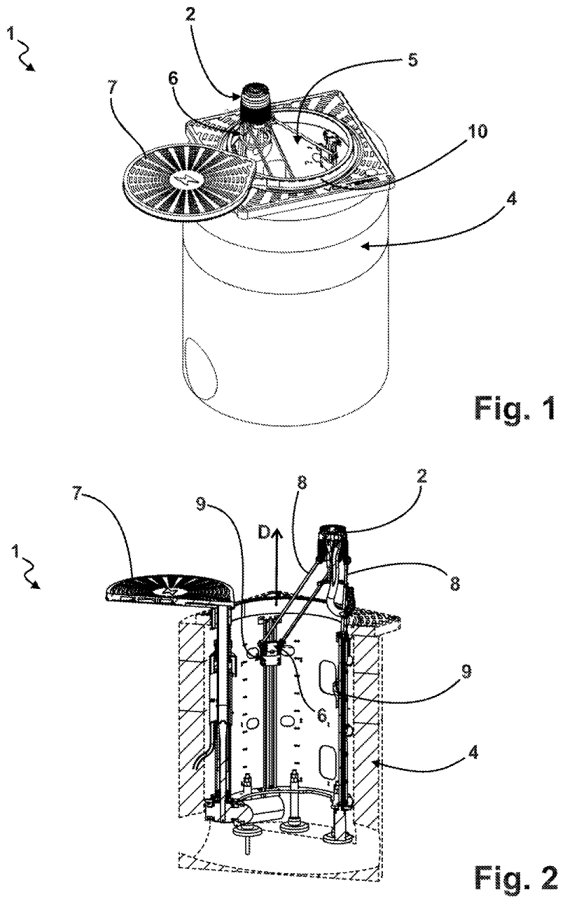

FIG. 1 shows a schematic illustration of a charging device with a first coupling element guided through the through-opening when the through-opening is open;

FIG. 2 shows a schematic illustration of the charging device from FIG. 1 in a cross section;

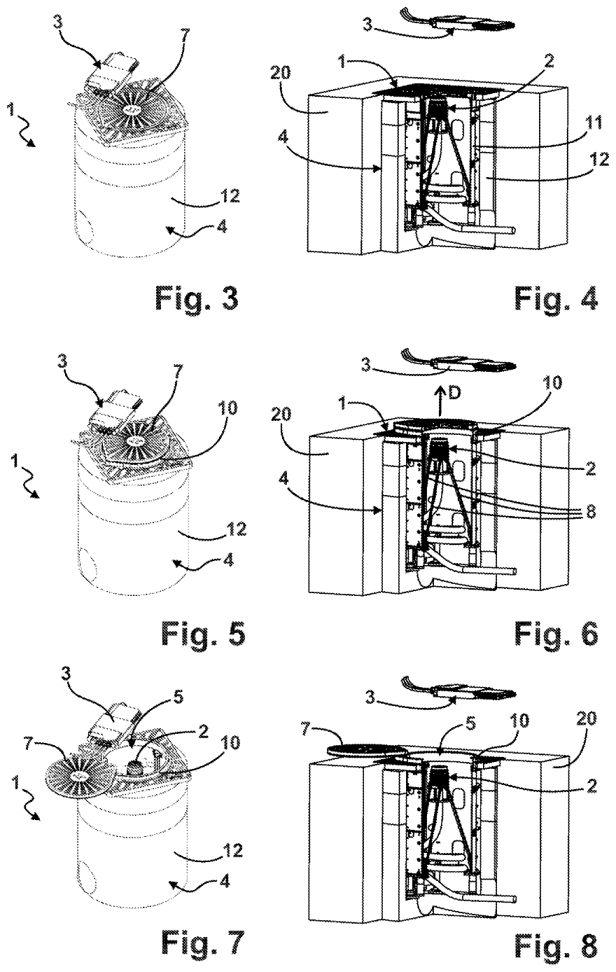

FIG. 3 through FIG. 10 show a sequence illustration of an electrical charging operation with the charging device from FIG. 1;

FIG. 11 shows a schematic illustration of a first coupling element and second coupling element in a cross section;

FIG. 12 shows a schematic illustration of the first coupling element from FIG. 11 in a cross section;

FIG. 13 shows a schematic illustration of a detail of the second coupling element from FIG. 11 in a cross section;

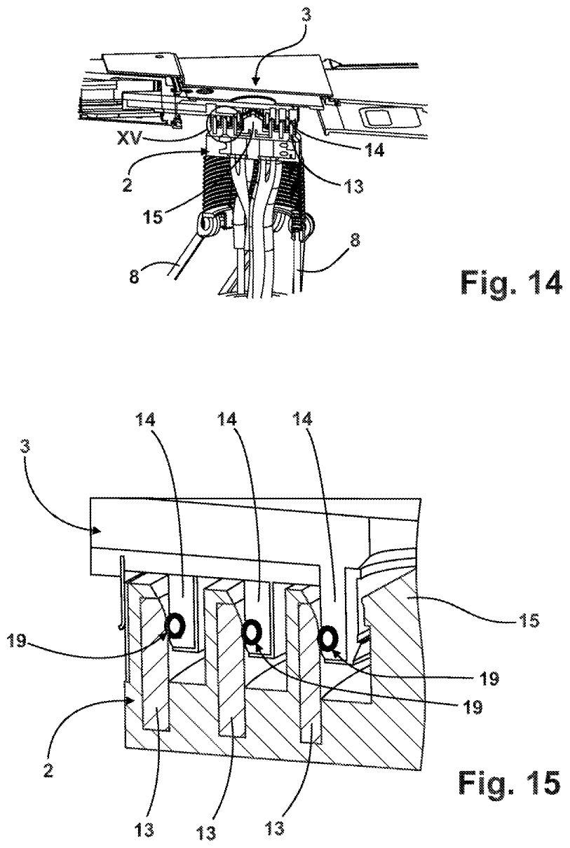

FIG. 14 shows a schematic illustration of the first coupling element and second coupling element from FIG. 11 in a contacted state;

FIG. 15 shows a schematic illustration of an enlarged detail from FIG. 14;

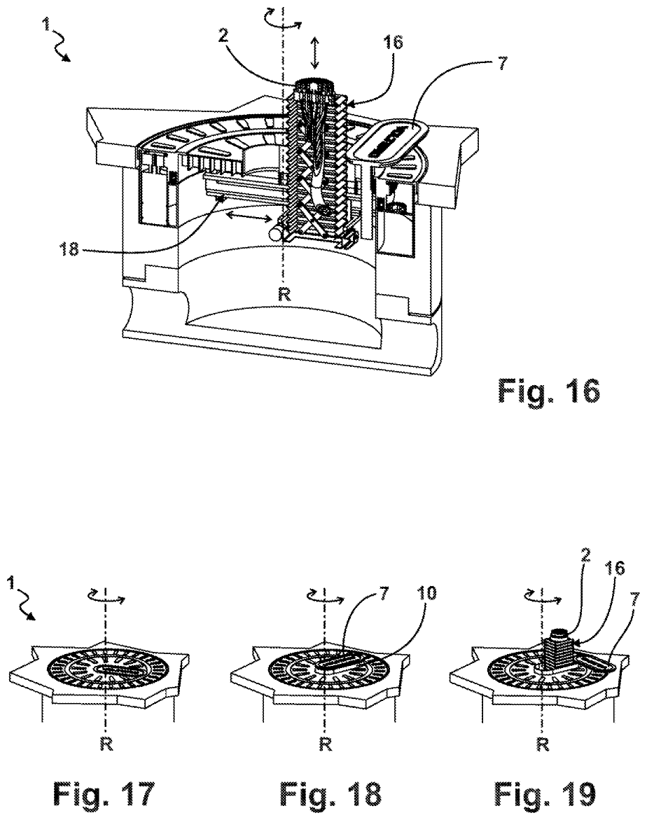

FIGS. 16 through 19 show schematic illustrations of a further embodiment of a charging device.

FIG. 1 shows a schematic illustration of a charging device 1 for electrically charging an electric vehicle, wherein the charging device 1 comprises a first coupling element 2 that can be connected to a second coupling element 3 arranged on the electric vehicle in order to produce an electrical connection. The charging device 1 comprises a base 4 that can be at least partially, preferably completely, sunk into the ground 20, which base 4 forms a hollow space or holding region in which the first coupling element 2 can be positioned in a non-charging state or a non-charging position. The base 4, or the hollow space thereof, comprises a through-opening 5 in order to guide the first coupling element 2, by passing the first coupling element 2 through the through-opening 5, from the non-charging position to the charging position, or to the second coupling element 3. For this purpose, the first coupling element 2 is connected to the base 4 such that it can be controllably moved with a movement apparatus 6. The movement apparatus 6 is preferably likewise located inside the hollow space of the base 4. Expediently, a cover 7 embodied as a lid is provided with which the through-opening 5 can be closed in order to prevent an ingress of soiling into the hollow space or holding region in the non-charging state. In the usage state of the charging device 1, in which the charging device 1 is arranged such that it is sunk into the ground 20, it is normally provided that the through-opening 5, or a rim of the base 4 that forms the through-opening 5, and/or the cover 7 are essentially located at the height of a ground level of the ground 20 in the non-charging state. In this manner, an electric vehicle can be positioned over the charging device 1, in particular the through-opening 5, for an electrical charging, in order to electrically charge said electric vehicle from an underside by passing the first coupling element 2 through the through-opening 5. Space is saved if the cover 7 can be moved essentially parallel to an opening surface of the through-opening 5 to open the through-opening 5. As can be seen in FIG. 1, the movement apparatus 6 can be formed with a parallel kinematic mechanism. For this purpose, the movement apparatus 6 preferably comprises multiple arms 8 controllable separately from one another, which arms 8 are attached in an articulated manner to the first coupling element 2 at spaced-apart contact points of the first coupling element 2. The first coupling element 2 can thus be moved by displacing the contact points using the arms 8.

FIG. 2 shows the charging device 1 from FIG. 1 in a cross section parallel to the pass-through direction D. It can be seen that the arms 8 are connected, by the respective arm ends thereof opposite from the contact points, in an articulated manner to guide components 9 arranged on the base 4, wherein the arm ends of the arms 8 can be displaced in a guided manner relative to the base 4 by the guide components 9, in order to move the contact points, or to move the first coupling element 2, by displacing the arms 8. For a high robustness, multiple arms 8 are preferably connected to one of the guide components 9 each in this case. The guide components 9 are typically arranged such that they are spaced apart from one another at regular intervals, preferably in a cross section along a periphery of a circle. The guide components 9 can be respectively formed with a guide component rail arranged on the base 4 and a guide component movement element that can be moved in a guided manner relative to the guide component rail using said rail. The arm ends are thereby connected to the guide component movement elements, usually in an articulated manner. For a high soiling resistance, it is beneficial if the base 4 comprises an extendable rim strip 10 that can be extended in the pass-through direction D, or orthogonally to the opening surface of the through-opening 5, so that, in the extended state, the rim strip 10 runs around the through opening 5 in order to form a barrier against soiling when the cover 7 is open, visible in FIG. 1. The rim strip 10 thereby typically protrudes past an external environment level or ground level.

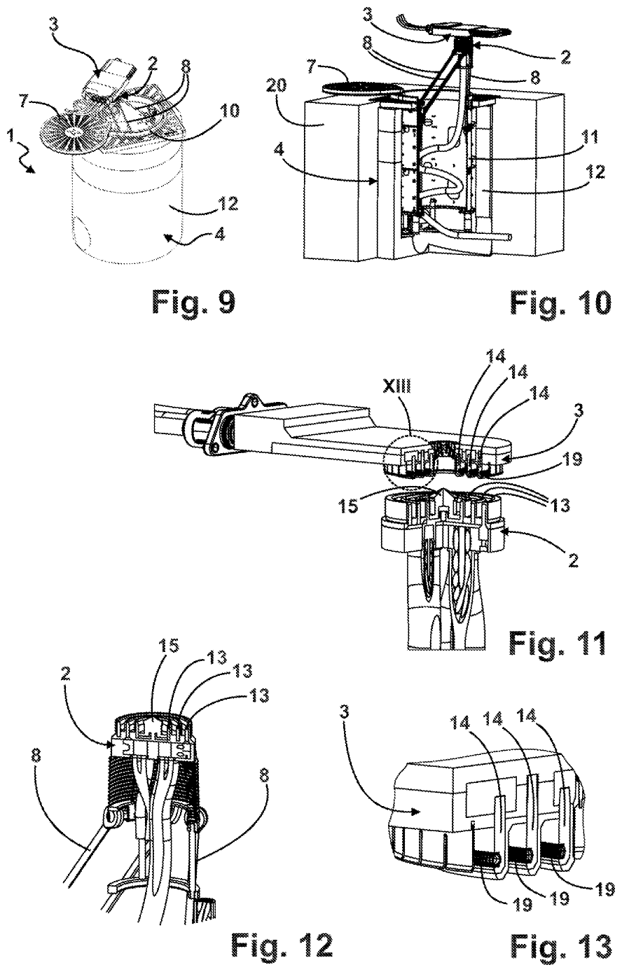

In FIG. 3 through FIG. 10, a sequence illustration of a charging operation with the charging device 1 from FIG. 1 is shown. Respectively illustrated are different operating states of the charging device 1 in the course of a process of an assumption of a charging position by the first coupling element 2 in order to contact a second coupling element 3. A particular operating state is respectively illustrated in an external view of the charging device and in a cross section through the charging device in a usage state arranged in the ground 20. FIG. 3 and FIG. 4 show the charging device 1 in the non-charging state. The first coupling element 2 is thereby located in the non-charging position thereof inside the base 4. The through-opening 5 is closed by the cover 7 in order to protect the first coupling element 2. A second coupling element 3 is positioned above the charging device 1. The second coupling element 3 is normally arranged on an electric vehicle or is embodied as part of such a vehicle. The base 4 comprises an outer envelope 12 which protectively encases a storage unit 11 of the base 4, which storage unit 11 forms a hollow space and in which the first coupling element 2 is arranged in the non-charging position. FIG. 5 and FIG. 6 show a first opening step of an opening movement of the cover 7, wherein the cover 7 is raised in the pass-through direction D of the through-opening 5 in order to subsequently open it with a movement parallel to the opening surface of the through-opening 5. The raising of the cover 7 occurs with a simultaneous extension of the rim strip 10. From a comparison of FIG. 4 and FIG. 6, it can be discerned that the raising of the cover 7 occurs with a raising of a wall element forming the rim strip 10. By providing that a raising of the cover 7 occurs with a telescope-like lengthening of the base 4, or of the storage space 11 thereof, the wall element at the same time forms an inner wall of the storage unit 11. FIG. 7 and FIG. 8 show a second opening step of an opening movement of the cover 7, wherein the cover 7 is preferably rotated in a plane parallel to the opening surface of the through-opening 5 in order to open the through-opening 5. A rotation motion of the cover 7 thereby takes place about a rotation axis positioned eccentrically from the through-opening 5. The through-opening 5 is open as a result, so that the first coupling element 2 can be guided, using the movement apparatus 6, from the non-charging position thereof into the charging position through the through-opening 5. This is shown in FIG. 9 and FIG. 10. The first coupling element 2 is passed through the through-opening by a displacement of the arms 8 of the movement apparatus 6 using the guide components 9 and guided to the second coupling element 3 in order to contact said second coupling element 3.

FIG. 11 shows a schematic illustration of a first coupling element 2, such as can be used in a charging device 1 from FIG. 1 or FIG. 16, and a second coupling element 3 in a cross section. The first coupling element 2 comprises multiple first contact elements 13 which can respectively be contacted with a corresponding second contact element 14 of a second coupling element 3 to produce an electrical connection while producing a compression connection, visibly illustrated in FIG. 12. The first contact elements 13 and second contact elements 14 are respectively embodied to be annular in a cross section through said elements, wherein the first contact elements 13 and second contact elements 14 are preferably arranged such that they are essentially spaced apart from one another concentrically with one another. In order to embody the first coupling element 2 and second coupling element 3 to be self-centering with one another, the first coupling element 2 normally comprises a guide nib 15, the outer surface of which is embodied to correspond in shape to a corresponding guide surface of a guide nib receptacle of the second coupling element 3 such that, in the case of a not entirely flush alignment of the first coupling element 2 relative to the second coupling element 3, the first coupling element 2 is guided into a flush alignment by the guide surface. For this purpose, the outer surface of the guide nib 15 is typically embodied with a conical envelope surface, as can be seen in FIG. 15. It shall be understood that an embodiment of the first coupling element 2 and second coupling element 3 is respectively independent from one another, and that they can be embodied in a different manner independently from one another, depending on an application purpose.

FIG. 13 shows a schematic illustration of a detail of the second coupling element 3 in a cross section. It has proven effective if a helical spring 19, preferably a helical spring 19 wound obliquely in relation to a center line through the coils thereof, runs around the first contact element 13 and/or second contact element 14, so that the compression connection between the first contact element and second contact element occurs with a deformation of the helical spring. The respective helical spring 19 is preferably arranged on the first contact element 13 or second contact element 14 such that it is located between the first contact element 13 and second contact element 14 in a contact state. As can be seen in FIG. 13, a helical spring 19 of this type respectively runs around the second contact elements 14. FIG. 14 shows the first coupling element 2 and second coupling element 3 from FIG. 11 in a connected state in a cross section. The first contact elements 13 of the first coupling element 2 are respectively connected to corresponding second contact elements 14 of the second coupling element 3 while producing a compression connection. This is visibly illustrated schematically as an enlarged detail in FIG. 15. The compression connection occurs in that a helical spring 19, preferably obliquely wound in relation to a center line through the coils thereof, is deformed. In FIG. 15, the respective helical spring 19 is arranged, by way of example, such that it runs around the respective second contact element 14, wherein the helical spring 19 is arranged in a form fit at least partially in a recess of the second contact element 14. In FIG. 15, the helical springs 19 are respectively illustrated schematically in cross section as ellipses.

FIGS. 16 through 19 show schematic illustrations of a further embodiment of a charging device 1. The charging device 1 can, in principle, thereby be embodied correspondingly to the charging device 1 from FIG. 1 and the features thereof with corresponding effects, in particular with an aforementioned first coupling element 2. In contrast to the charging device 1 from FIG. 1, the charging device 1 from FIG. 16 comprises a movement apparatus 6 embodied differently. As can be seen in FIG. 16, the movement apparatus 6 comprises a lifting apparatus 16 with which the first coupling element 2 can be moved through the through-opening 5. This can expediently be formed with a scissor lift mechanism. The lifting apparatus 16 is connected to a lateral movement system 17, with which the lifting apparatus 16, and therefore the first coupling element, can be moved in two dimensions in a movement plane parallel to the opening surface of the through-opening 5. For this purpose, the lateral movement system 17 comprises a linear guide 18, along which the lifting apparatus 16 can be moved in a straight line, wherein the linear guide 18 can be rotated about a rotation axis R oriented orthogonally to the movement plane. It is beneficial if the through-opening 5 and the cover 7 can be moved about the rotation axis R in tandem corresponding to a rotational position of the coupling element 2. As a result, the cover 7 can be embodied to be small, in particular such that it is adapted to a size of the first coupling element 2. In FIG. 17 and FIG. 18, different rotational positions of a through-opening 5 and cover 7 of this type are illustrated. According to the aforementioned statements, it is beneficial if the base 4 comprises an extendable rim strip 10 in order to form a barrier against soiling when the cover 7 is open, visible in FIG. 18. FIG. 19 shows an operating state with the cover 7 open, wherein the first coupling element 2 has been passed through the through-opening 5 using the lifting apparatus, in order to assume a charging position. The cover 7 is expediently embodied as a lid.

An aforementioned charging device 1 enables, as a result of the optimization thereof for a usage state arranged such that it is sunk into the ground 20, a robust and low-soiling electrical charging of an electric vehicle. In the non-charging state, the first coupling element 2 is particularly protected due to the positioning thereof inside of the base 4. Because the cover 7 can be opened by a combination of a raising orthogonal to the opening surface of the through-opening 5 and a subsequent rotation parallel to the opening surface, an operation can be carried out such that it saves space and reduces soiling. It is beneficial if an extendable rim strip 10 is provided which protects the through-opening 5 against soiling when the cover 7 is open. If the first coupling element 2 is equipped with obliquely wound helical springs 19, in order to produce a compression connection between the first contact elements 13 and second contact elements 14 corresponding thereto through a deformation of the helical springs 19, an electrical contact that is lasting and robust against soiling can be implemented. The charging device 1 thus in particular enables a robust and soiling-resistant electrical charging in an outdoor region, specifically even in poor weather conditions.

1. A charging device for electrically charging an electric vehicle, wherein the charging device comprises a first coupling element that can be connected to a second coupling element arranged on the electric vehicle to produce an electrical connection, wherein the charging device comprises a base, which can be at least partially sunk into the ground, and a movement apparatus, which connects the first coupling element to the base such that it can be controllably moved relative to the base, wherein the base comprises a through-opening and a cover that closes the through-opening, so that, in a usage state, the first coupling element can, with the cover open, be moved through the through-opening from a non-charging position sunk into the ground using the movement apparatus, in order to guide the first coupling element to the second coupling element to assume a charging position.

2. The charging device according to claim 1, wherein the first coupling element can be moved using the movement apparatus relative to the base along multiple movement axes preferably aligned at a right angle to one another, in particular independently of one another, in order to assume the charging position.

3. The charging device according to claim 1, wherein the movement apparatus comprises a parallel kinematic mechanism.

4. The charging device according to claim 1, characterized in that wherein the movement apparatus comprises multiple arms separately controllable from one another, which arms grip in an articulated manner the first coupling element at spaced-apart contact points of the first coupling element in order to move the first coupling element by displacing the contact points using the arms.

5. The charging device according to claim 1, wherein the movement apparatus comprises a lifting apparatus, with which the first coupling element can be moved through the through-opening, and a lateral movement system, with which the first coupling element can be moved in two dimensions in a movement plane parallel to an opening surface of the through-opening.

6. The charging device according to claim 1, wherein the movement apparatus is embodied to move the first coupling element laterally past a rim of the through-opening.

7. The charging device according to claim 1, wherein the base is formed with a hollow body in which, in the non-charging state, the first coupling element and preferably the movement apparatus are arranged.

8. The charging device according to claim 1, wherein the cover can be moved essentially parallel to the opening surface of the through-opening to open the through-opening.

9. The charging device according to claim 1, wherein, to open the through-opening, the cover can be raised in a pass-through direction of the through-opening and can subsequently be moved essentially parallel to the opening surface of the through-opening.

10. The charging device according to claim 1, wherein the base comprises a rim strip that can be extended relative to a foundation of the base, so that, in the extended state, the rim strip at least partially runs around the through-opening in order to form a barrier against dirt that ingresses into the through-opening when the cover is open.

11. The charging device according to claim 1, wherein at least one sensor element is present for measuring an impediment to an opening movement or closing movement of the cover.

12. The charging device according to claim 1, wherein the first coupling element and/or the movement apparatus are mounted on the base with a spring mechanism, in order to compensate a change in spacing between the second coupling element and the base in a state of electrical charging.

13. The charging device according to claim 1, wherein the first coupling element comprises at least one first contact element and a helical spring wound obliquely in relation to a center line through the coils thereof, in order to electrically contact the first contact element with a second contact element, corresponding to said first contact element, of the second coupling element while producing a compression connection formed with a deformation of the helical spring.

14. A charging system for electrically charging an electric vehicle, wherein a charging device according to claim 1 and a second coupling element that can be arranged on an electric vehicle are present, wherein the first coupling element and the second coupling element can be connected to one another in a form fit to produce an electrical connection.

15. The charging system according to claim 14, wherein, to produce an electrical connection between the first coupling element and second coupling element, at least one first contact element of the first coupling element can be electrically contacted with at least one second contact element, corresponding to said first contact element, of the second coupling element while producing a compression connection, wherein the compression connection is created with a deformation of at least one helical spring wound obliquely in relation to a center line through the coils thereof.

16. The charging system according to claim 15, wherein the at least one first contact element and/or the at least one second contact element is essentially circular in a cross section through the contact element and the helical spring, or the center line thereof, runs around the at least one first contact element and/or the at least one second contact element.

17. The charging system according to claim 14, wherein the respective coupling element comprises in a cross section through said coupling element multiple circular first contact elements or second contact elements, wherein the contact elements are arranged in an offset manner, in particular concentrically with one another, wherein for respectively corresponding contact elements of the two coupling elements, one helical spring is present, the center line of which runs around at least one of the contact elements corresponding to one another, in order to create an electrical contact between the corresponding contact elements while producing a compression connection with the respective helical spring.

18. A method for electrically charging an electric vehicle, wherein, to electrically charge a storage battery of the electric vehicle, the electric vehicle is positioned at a charging device in order to connect a first coupling element of the charging device to a second coupling element arranged on the electric vehicle, in order to transfer electrical energy to the storage battery via the coupling elements, wherein the charging device is embodied according to claim 1, wherein the base is at least partially sunk into the ground and the electric vehicle is positioned above the charging device, whereupon, with the cover open, the first coupling element is moved through the through-opening from a non-charging position sunk into the ground using the movement apparatus, in order to guide the first coupling element to the second coupling element to assume a charging position.
